(19) United States
(12) Patent Application Publication
(10) Pub. No.: US 2022/0020086 A1
(43) Pub. Date: Jan. 20, 2022

(54) VEHICLE DEALERSHIP DATA MANAGEMENT SYSTEM

(71) Applicants: Jeremy Kuchenbecker, Winter Springs, FL (US); Veronica Kuchenbecker, Winter Springs, FL (US); Matt Olson, Waukesha, WI (US)

(72) Inventors: Jeremy Kuchenbecker, Winter Springs, FL (US); Veronica Kuchenbecker, Winter Springs, FL (US); Matt Olson, Waukesha, WI (US)

(21) Appl. No.: 16/930,338

(22) Filed: Jul. 16, 2020

(51) Int. Cl. G06Q 40/02; G06Q 10/10

(52) U.S. Cl. CPC G06Q 40/02; G06Q 10/1093

(57) ABSTRACT

A vehicle dealership data management system is disclosed, comprising at least one database configured to store a plurality of vehicle information, customer information, sales information, and finance information, each provided on a display of a computing device. A server engine is in operable communicate with the database via a server, the server engine operating a sales module, an inventory module, and a financing module. A communications module transmits communication between the sales module, the inventory module, and the financing module.

### TECHNICAL FIELD

The embodiments generally relate to automotive dealership management software and, more particularly, relate to automotive client relationship management and dealership data management system.

### BACKGROUND

Automotive, recreational vehicle, motorcycle, and watercraft retailers have long been automated using business software. Although some dealerships use web browsers to display stored or aggregated data from other systems, this is a read-only process using the browser. The ubiquitous use of the internet has allowed dealerships to communicate to employees and partnered dealerships and service centers to communicate inventory data, scheduling, and other communications. However, these systems are spread across numerous platforms which are disconnected from one another.

A dealership often comprises various departments including sales, financing, accounting, management, and in some cases service departments. Each department provides a service to the consumer at various points throughout the purchase and ownership of the vehicle or fleet of vehicles. For example, the sales department manages the consumer experience prior to purchasing a vehicle. This may include offering test drives, scheduling appointments to view inventory, and negotiating a sales price, options, and the like. The sales department may then transfer the consumer to the finance department to provide finance options and the negotiation thereof. Many dealerships may not have an efficient means for transferring information input during the sales process to the finance department.

In another example, many consumers will perform a considerable amount of research across multiple dealership locations to ensure they are purchasing a suitable vehicle at a reasonable cost. Consumers showing a particular level of interest may be considered a valuable lead. In the current arts, few systems exist which allow the dealership to manage information for leads across various dealership locations. This may be further exacerbated for commercial clients managing a fleet of vehicles.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a vehicle dealership data management system, comprising at least one database configured to store a plurality of vehicle information, customer information, sales information, and finance information, each provided on a display of a computing device. A server engine is in operable communicate with the database via a server, the server engine operating a sales module, an inventory module, and a financing module. A communications module transmits communication between the sales module, the inventory module, and the financing module.

The system allows for dealership personnel to communicate customer, vehicle, and finance information through the ecosystem to ensure the accurate and efficient transmission of information related to the purchasing and financing of a vehicle.

In one aspect, the vehicle information comprises at least one of the following: a vehicle make, a vehicle model, a vehicle year, a plurality of vehicle options, and a vehicle color.

In one aspect, a presentation module presents the vehicle information, the sales information, the customer information, and the finance information on the display of the computing device.

In one aspect, the sales module receives user input and transmits the sales information to the database operable to communicate the sales information to the financing module.

In one aspect, the financing module receives user information including finance information, wherein the finance information is stored in the database.

In one aspect, a calendar module schedules one or more events input by a user.

In one aspect, the system comprises a vehicle data system configured to display vehicle information and transmit the vehicle information to a plurality of third parties.

In one aspect, the third parties comprise one or more financial institutions and the Department of Motor Vehicles.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the vehicle information system, according to some embodiments;

FIG. 3 illustrates a block diagram of the server engine and modules, according to some embodiments;

FIG. 4 illustrates a block diagram of the sales processing system, according to some embodiments;

FIG. 5 illustrates a block diagram of the financing processing module, according to some embodiments;

FIG. 6 illustrates a flow chart of the lead processing methods, according to some embodiments; and

FIG. 7 illustrates a flow chart of the finance process, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “user” may relate to any person interacting with the system and may be most useful for sales, marketing, finance, and service professionals associated with a vehicle dealership or network of dealerships.

The embodiments may be used by various forms of dealerships including automotives, watercraft, commercial vehicles, trucks, recreational vehicles, motorcycles, and the like. Similarly, the system may be used by dealerships selling new or used vehicles.

In general, the embodiments provide a system for managing vehicle dealership information across a plurality of departments including sales information, financing information, inventory information, servicing information, and the transmission between each such that users of the system are in communication within the ecosystem.

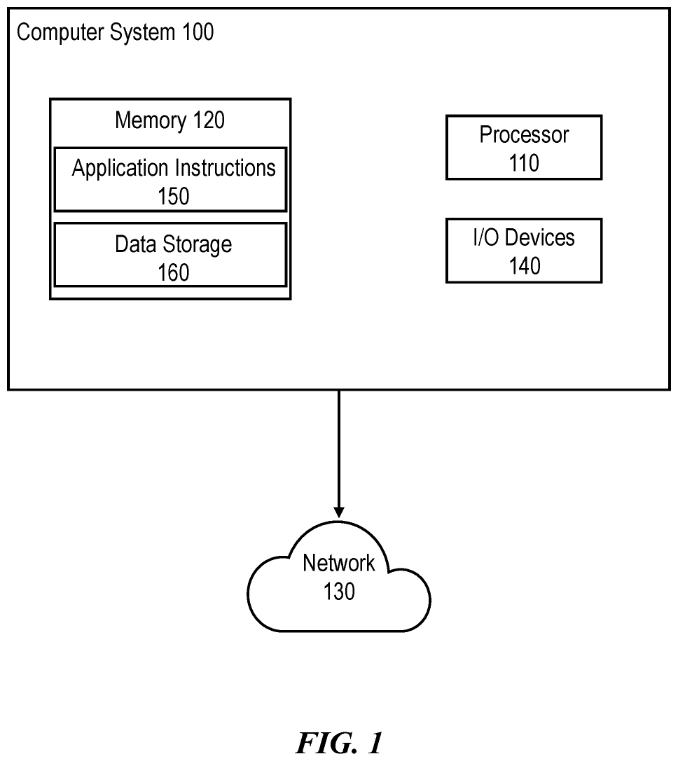

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

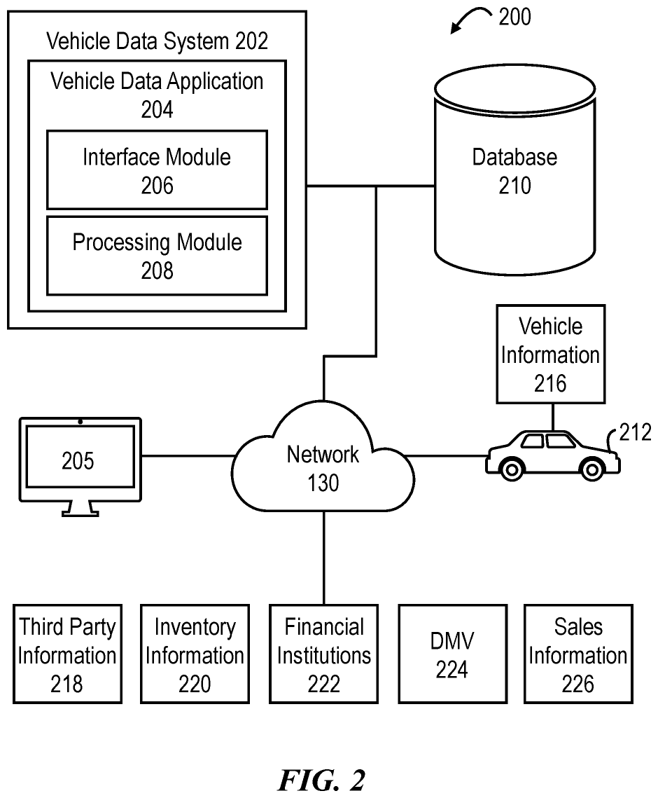

FIG. 2 illustrates a block diagram of the car dealership data management system 200 (hereinafter referred to as the “system”) comprising a vehicle data system 202 configured to transmit and receive a plurality of vehicle information 216 corresponding to the vehicles 212 at the local dealership or connected dealerships in communication with the network 130. The vehicle data system 202 includes a vehicle data application 204 configured to provide vehicle information 216 to a display of a client device 205 via an interface module 206. A processing module 208 transmits and implements data changes made by the user. A database 210 stores vehicle information 216, dealership information, finance information, sales information 226, or other information associated with the vehicle selling, financing, and buying processes. Each vehicle 212 is provided with associated vehicle information 216 which is stored in the database 210 and may be transmitted to various aspects of the system 200. The system 200 allows information to be transmitted to and from various external systems, users, and associated information including third party information 218, inventory information 220, financial institutions 222, the Department of Motor Vehicles (DMV) 224, and sales information 226.

As used herein, the term “vehicle information” may include vehicle make, model, year, condition, upgrade packages, trim, interior, data packages, vehicle capabilities and specifications, performance statistics, color, accessories, price, financing options, vehicle history, vehicle identification number, and the like. One skilled in the arts will readily understand that various vehicle information 216 may be provided to users of the system, financial institutions 222, inventory personnel, third-parties, government organizations (e.g., Department of Motor Vehicles), and the like.

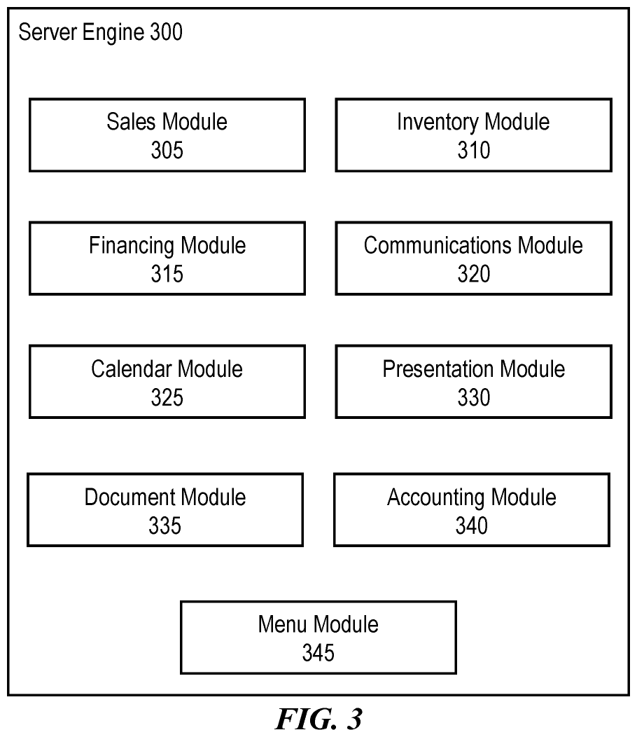

FIG. 3 illustrates a block diagram of the server engine 300 comprising a sales module 305, inventory module 310, financing module 315, communications module 320, calendar module 325, and presentation module 330, a document module 335, an accounting module 340, and a menu module 345. The sales module 305 provides various functionalities related to a vehicles sales system including sales pricing information, sales promotion system, and the like. The sales module 305 may provide the user with sales information, which may be updated by an administrative user. For example, the sales module 305 may process and display discounts, promotions and the like to inform the sale professionals of a change in prices, terms, and the like. The inventory module 310 provides real-time inventory information to the user. For example, the inventory module 310 may permit the user to search vehicle inventory across multiple dealerships. The financing module 315 allows the user to access financing systems which may include generating finance agreements, generating terms, and calculating finance costs. A communications module 320 is operable to permit communications between the various users of the system and their associated departments. For example, the communications module 320 provides a means for transmitting sales information to the financing department for processing. A calendar module 325 allows the user or customers to schedule events, such as scheduling a vehicle showing, or to schedule payments. A presentation module 330 provides a means for displaying the various information within the system to the display of a computing device. The presentation module 330 allows the user to interact with the system while displaying relevant information to the user. A document module 335 provides a means for generating and filling in documents related to the sale, financing, and purchasing of a vehicle. For example, the document module may automatically provide required documents to each step of the vehicle purchasing process, provide a means for filling in the documents, and transmitting the documents to the appropriate users/parties. The accounting module 340 may permit the input of accounting information to allow the accounting department of a dealership to monitor and manage accounting for various aspects of the dealership. A menu module 345 provides a plurality of selectable tabs in a menu allowing the user to navigate through the user interface of the system, as well as input information into the system via an on-screen menu.

In some embodiments, the calendar module 325 aggregates data in a calendar view which may be provided in a daily, weekly, monthly, etc. view. The calendar module 325 may store data in the calendar view such that the user can navigate through a calendar interface to permit the user to engage with the information therein. The calendar module 325 may be used by the dealership personnel or other users of the system. In one example, managers at the dealership may aggregate individual dealership information into the calendar by day, month, week, etc. Further, sales personnel may view the calendar interface to view appointments and tasks.

In some embodiments, active leads include in-store leads or remote leads at other dealerships. This may be especially useful for internet-based sales teams to track their leads that were transmitted via a website associated with the dealership, manufacturer, and the like.

The user may perform a lead search to view “parent” customers that may be used to track all leads within a dealer group across various dealerships. This will allow the user to isolate individual sales cycles for a particular customer. For example, a customer buys a car from a first dealership in June of 2018. The same customer visits a second dealership in June of 2020 to purchase another vehicle. Each sales transaction is stored in reference to the customer.

In some embodiments, the sales log includes a record of all deposits taken on vehicles that have been sold. If a deposit is cancelled or refunded, the user may view the reasons for the cancellation or refund.

In some embodiments, a finance dashboard is used by the finance department of a dealership to view current finance revenue and manage the dealership deliveries. The finance dashboard may indicate that a delivery is ready (i.e., the customer is ready to sign delivery paperwork and consummate the delivery), that the delivery is scheduled (i.e., the delivery has been scheduled for a particular day and time), and that the delivery is delivered (i.e., the delivery is already delivered).

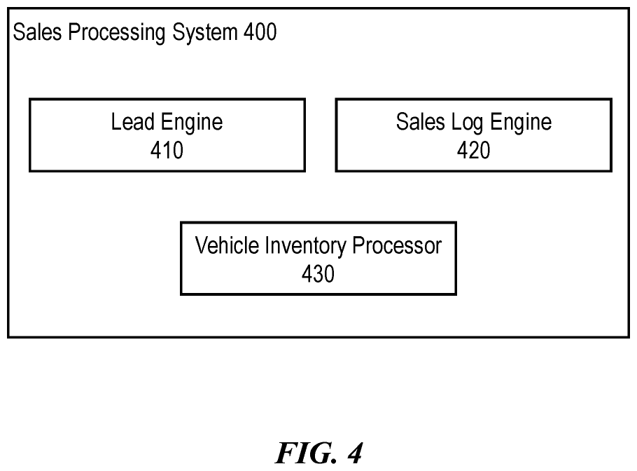

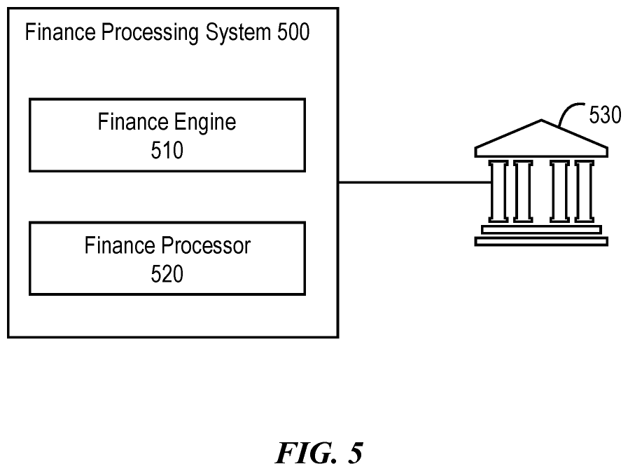

FIG. 4 illustrates a block diagram of the sales processing system 400 comprising a lead engine 410, sales log engine 420, and vehicle inventory processor 430. The lead engine 410 allows the user to input lead information such as, for example, client contact information, lead details, and similar information which may be useful to the sales representative, account manager, or other user of the system. A sales log engine 420 may process historical sales information for a customer or group thereof. This may be especially useful for clients managing a fleet of vehicles to allow the dealership to view fleet purchase history. A vehicle inventory processor 430 allows the user to interact with vehicle inventory information as well as submit a work order for one or more vehicles within the vehicle inventory. Information related to a customer and/or vehicle may be transmitted from the sales processing system to the finance processing system 500 (shown in FIG. 5) to allow various users in the sales and finance teams of a dealership to readily communicate information to and from one another.

In some embodiments, the system allows for the user to view closed deals presented via the sales log engine. The closed deals may be transmitted to the accounting module, or other module for processing. Similarly, closed deals and the information thereof may be stored in the database for future reference and may be interacted with upon subsequent purchases by the customer. For example, the document module provides a plurality of documents to the user. Once completed and the sale of the vehicle is finalized, the documents are stored and provided to an accounting module for processing or storage for future interactions.

FIG. 5 illustrates a finance processing system 500 utilized by the user to generate, communicate, and/or process finance information. The finance processing system 500 includes a finance engine 510 and finance processor 520 to communicate finance information to a financial institution 530. The finance processing engine 500 is in operable communication with the sales processing system 400 (provided in FIG. 4) to allow the users thereof to communicate sales information to the financing processing system 500.

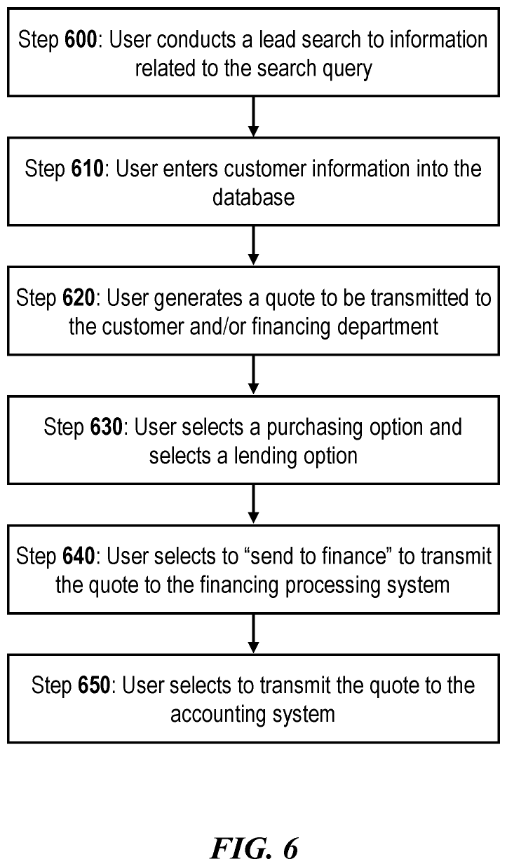

FIG. 6 illustrates a flowchart of the lead processing method which allows the user to perform a lead search, enter customer data, generate a quote, and otherwise manage various processes associated with the sale, trade-in, or purchasing of a vehicle. In step 600, the user conducts a lead search, which may display customers relevant to the search terms input by the user. If there is no match to the search terms, the user may start a new lead. If there is a match, the user may select to start a new lead or continue a lead from an existing sales cycle. In step 610 the user enters customers information (e.g., addresses, contact information, emails, payment information, insurance information, etc.). In step 620, the user generates a quote to be transmitted to the customer. The quote may include a feature to add a vehicle using a search engine to input a vehicle identification number (VIN), year, make, model, color, stock number, options, etc. Optionally, the user may find a matching vehicle using a search menu (e.g., a series of drop-down menus). In step 630, the user selects a purchasing option, such as lease, loan, cash, etc. The user may be provided the option to select a lender or financial institution to process the payment, loan, or the like. The user may input associated taxes, fees, trade-in information, and the like, which is then added to the quote. An incentives option may be provided to illustrate incentives from one or more lenders. Similarly, the user may select special offers, term options, and similar information to include in the quote. A payment analytics engine may illustrate the gross profit, finance gross profit, etc. related to the quote. In step 640, the user may select a “send to finance” option to transmit the quote to the finance system. Lastly, in step 650, the user may select to transmit the information to the accounting system which allows for users to interact with closed deals. The accounting system may also provide access to historical data related to vehicle sales, financing, and the like.

In some embodiments, the accounting system allows the user to adjust ledgers, finalize a financing deal, finalize a sale, and determine and indicate if a deal has been closed or if it requires further interaction.

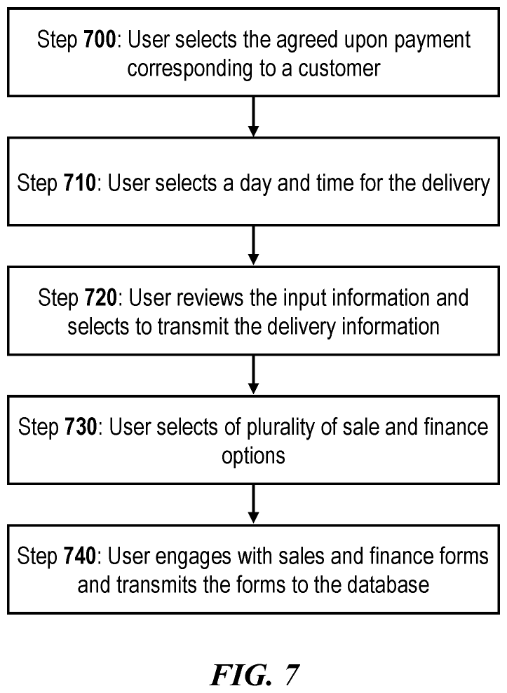

FIG. 7 illustrates a finance process wherein the user may first select the agreed upon payment for the customer in step 700. In step 710, the user selects a day and time for the delivery of the vehicle, or the user may select an immediate delivery option. In step 720, the user reviews the information and selects to transmit the delivery of the information. In step 730, the user selects a plurality of options using a finance dashboard to select an appropriate deal and to review buyer, co-buyer, vehicle, quote, trade-in, or similar information provided by the system. In step 740, the user may engage with various forms associated with vehicle buying, selling, and financing processes. The user may select from pre-generated forms or manually generated forms for engagement. A menu template may be provided which further includes various templates, add/remove options and accessory products, select terms, select upgrade packages, and select financing packages.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A vehicle dealership data management system, comprising:
at least one database configured to store a plurality of vehicle information, customer information, sales information, and finance information, each provided on a display of a computing device;
a server engine in operable communicate with the database via a server, the server engine operating a sales module, an inventory module, and a financing module; and
a communications module to transmit communication between the sales module, the inventory module, and the financing module.

2. The system of claim 1, wherein the vehicle information comprises at least one of the following: a vehicle make, a vehicle model, a vehicle year, a plurality of vehicle options, and a vehicle color.

3. The system of claim 1, further comprising a presentation module to present the vehicle information, the sales information, the customer information, and the finance information on the display of the computing device.

4. The system of claim 3, wherein the sales module receives user input and transmits the sales information to the database operable to communicate the sales information to the financing module.

5. The system of claim 4, wherein the financing module receives user information including finance information, wherein the finance information is stored in the database.

6. The system of claim 5, further comprising a calendar module to schedule one or more events input by a user.

7. The system of claim 6, wherein the system comprises a vehicle data system configured to display vehicle information and transmit the vehicle information to a plurality of third parties.

8. The system of claim 7, wherein the third parties comprise one or more financial institutions and the Department of Motor Vehicles.

9. A vehicle dealership data management system, comprising:
at least one database configured to store a plurality of vehicle information, customer information, sales information, and finance information, each provided on a display of a computing device;
a server engine in operable communicate with the database via a server, the server engine operating a sales module, an inventory module, and a financing module;
a sales processing engine in operable communication with a financing processing engine via a server to permit the communication of the sales information to the financing processing engine; and
a communications module to transmit communication between the sales module, the inventory module, and the financing module.

10. The system of claim 9, wherein the vehicle information comprises at least one of the following: a vehicle make, a vehicle model, a vehicle year, a plurality of vehicle options, and a vehicle color.

11. The system of claim 10, further comprising a presentation module to present the vehicle information, the sales information, the customer information, and the finance information on the display of the computing device.

12. The system of claim 11, wherein the sales module receives user input and transmits the sales information to the database operable to communicate the sales information to the financing module.

13. The system of claim 12, wherein the financing module receives user information including finance information, wherein the finance information is stored in the database.

14. The system of claim 13, further comprising a calendar module to schedule one or more events input by a user.

15. The system of claim 14, wherein the system comprises a vehicle data system configured to display vehicle information and transmit the vehicle information to a plurality of third parties.

16. The system of claim 15, wherein the third parties comprise one or more financial institutions and the Department of Motor Vehicles.

17. The system of claim 16, wherein the sales processing system comprises a lead engine, sales log engine, and a vehicle inventory processor.

18. The system of claim 17, wherein the financing processing system comprises a finance engine and a finance process in operable communication with a financial institution.

19. The system of claim 18, wherein the lead engine and sales log engine permit the user to input lead information and historical sales information each transmitted to the database.

20. A vehicle dealership data management system, comprising:
at least one database configured to store a plurality of vehicle information, customer information, sales information, and finance information, each provided on a display of a computing device;
a server engine in operable communicate with the database via a server, the server engine operating a sales module, an inventory module, and a financing module;
a sales processing engine in operable communication with a financing processing engine via a server to permit the communication of the sales information to the financing processing engine, the sales processing engine to permit a user to input the sales information via a lead engine and a sales log engine, wherein the financing processing engine receives the sales information and permits the user to input financing information via a finance engine; and
a communications module to transmit communication between the sales module, the inventory module, and the financing module.
